(19) United States
(12) Patent Application Publication
(10) Pub. No.: US 2006/0208500 A1
(43) Pub. Date: Sep. 21, 2006

(54) Door locking system

(76) Inventor: Jeffrey W. Brown, San Jose, CA (US)

Correspondence Address: ILLINOIS TOOL WORKS INC., 3600 WEST LAKE AVENUE, PATENT DEPARTMENT, GLENVIEW, IL, 60025, US

(21) Appl. No.: 11/338,227

(22) Filed: Jan. 24, 2006

Related U.S. Application Data
(60) Provisional application No. 60/662,024, filed on Mar. 15, 2005.

(51) Int. Cl. E05C 3/06

(52) U.S. Cl. 292/201

(57) ABSTRACT

A door lock system includes a deflectable beam, a pawl positioned on the deflectable beam, a lever member that exerts a force into at least a portion of the deflectable beam, and first and second conductive wires attached to the lever member. The first conductive wire contracts when heated, thereby pulling on the lever member and pivoting the lever member into a first position in which the deflectable beam deflects so that the pawl is moved into a locked position. The second conductive wire contracts when heated, thereby pivoting the lever member into a second position in which the deflectable beam deflects so that the pawl is moved into an unlocked position.

### RELATED APPLICATIONS

This application relates to and claims priority benefits from U.S. Provisional Patent Application 60/662,024 entitled “Door Locking Mechanism,” filed Mar. 15, 2005, which is hereby incorporated by reference in its entirety.

### FIELD OF THE INVENTION

Embodiments of the present invention generally relate to a door locking mechanism, and more particularly to a door locking system for an appliance, such as, for example, a washing machine. Although embodiments of the invention are described with respect to a washing machine, embodiments of the invention may be used in various other applications.

### BACKGROUND OF THE INVENTION

Typical washing machines include electronic door locks that are configured to prevent a user from opening a door or lid of the washing machine during operation, such as a spin cycle. One such door lock uses a bimetal element with a positive temperature coefficient (PTC) pill that is configured to actuate an over-center member between open and closed positions.

FIG. 1 illustrates a top exploded view of a conventional door lock mechanism 10. The door lock mechanism 10 includes a main module 12, a slider housing 14, and a cover 16. The main module 12 is configured to snapably secure to the slider housing 14. The cover 16 is configured to snapably mount over the main module 12.

The slider housing 14 includes a main mounting body 18, a spring 20 secured within the main mounting body 18, and a sliding member 22 slidably retained within the main mounting body 18. The main mounting body 18 includes fastener receptacles 24 that allow the main mounting body 18 to be secured to a washing machine (not shown).

When the washing machine door (not shown) is closed, a striker (not shown) mounted on the door engages the sliding member 22 and moves it into the spring 20, thereby compressing the spring 20. When the door is opened, the spring 20 returns to its original shape, and exerts a force into the sliding member 22, thereby moving the sliding member 22 to its original position.

FIG. 2 illustrates a bottom view of the main module 12. A pawl opening 26 is formed through an underside 28 of the main module 12. Referring to FIGS. 1 and 2, movement of the sliding member 22 in the slider housing 14, causes a pawl window 30 of the sliding member 22 to move into alignment with the pawl opening 26. When the door lock mechanism is electrically energized, a pawl 32 ejects from the main module 12 and passes through the pawl opening 26 and the aligned pawl window 30 into the sliding member 22. The ejected pawl 32 prevents the sliding member 22 from sliding back to its original position, thereby effectively locking the door.

Referring again to FIG. 1, the main module 12 also includes a PTC pill 34 that is positioned with respect to a bimetal beam (hidden underneath the PTC pill 34). The temperature of the PTC pill 34 increases as electrical current is passed therethrough. Because the PTC pill 34 contacts the bimetal beam, the temperature change of the PTC pill 34 causes the bimetal beam to flip. That is, the bimetal beam moves from a virtually flat orientation to a bowed orientation. As the bimetal beam bows, the bimetal beam moves the PTC pill 34 into engagement with an over-center member 38, which is formed of an electrically conductive material with an integral electrical terminal. As the PTC pill 34 pushes the over-center member 38, the over-center member 38 moves or snaps from an open position to a closed position.

Movement of the over-center member closes a set of electrical switch contacts (not shown) and pushes the pawl 32, which is attached to the over-center member 38, outwardly from the main module 12. Each electrical switch contacts is a safety device that sends a signal to a processing unit of the washing machine to communicate that the door or lid has been closed.

When electrical power is cut, and current ceases to flow through the door lock mechanism 10, the PTC pill 34 cools, and the bimetal beam flips back to its original flat position. Consequently, the over-center member 38 moves back to an open position, and the switch contacts open (indicating the door may not be closed all the way). Further, the pawl 32 retracts into the main module 12. A spring 40 biases the over-center member 38 towards its original position. The PTC pill 34 overcomes the force exerted by the spring 40 when the PTC pill 34 is energized. When the PTC pill 34 is de-energized, the force exerted by the spring 40 into the over-center member 38 assists in returning the over-center member 38 to its original position. Additionally, the sliding member 22 is free to slide back, assisted by the force exerted by the spring 20, to its original position when the washing machine door is opened. The cool down period for the PTC pill 34 typically takes time, usually between thirty to ninety seconds.

As evident by the description above, the door lock mechanism includes many components in order to operate. In particular, the door lock mechanism described above includes various components used to move the pawl between locked and unlocked positions. Additionally, in order to maintain the pawl 32 in a locked condition, the PTC pill 34 is continually energized. Further, while the delay associated with the cooling of the PTC pill 34 was acceptable in the past because washing drums were allowed to spin to a stop, modern washing machines include braking systems for spinning drums. As such, many users desire quicker access to the drums after the wash process is complete.

Thus, a need exists for a simpler and more efficient door lock system. Additionally, a need exists for a door lock system that allows a door to be unlocked quicker. Further, a need exists for a door lock system that does not need to be continually energized in order to stay locked.

### SUMMARY OF THE INVENTION

Embodiments of the present invention provide a door lock system that includes a deflectable beam that has a beam fixed end and a beam free end, a pawl positioned on the deflectable beam, a lever member exerting a force into at least a portion of the deflectable beam, and first and second conductive wires attached to the lever member. The lever member may include a lever fixed end a lever free end.

Electrical leads electrically connect to the first and second conductive wires, and are configured to allow electrical current to pass to and through the first and second conductive wires. The ensuing electrical current through the wires serves to heat the wires.

The first conductive wire contracts when heated, thereby pulling on the lever member and pivoting the lever member into a first position that deflects the deflectable beam so that the pawl is moved into a locked position. The second conductive wire contracts when heated, thereby pivoting the lever member into a second position that deflects the deflectable beam so that the pawl is moved into an unlocked position.

The lever member may include a lever arm connected to a spring, wherein a distal end of the spring contacts the deflectable beam. The spring may be shaped in the form of a horseshoe.

The lever member may pivot in a first direction, while the deflectable beam deflects in a second direction that is opposite the first direction when one of the first and second conductive wires contracts. Optionally, the lever arm and the deflectable beam may both move in a first direction when one of the first and second conductive wires contracts.

After the pawl is moved into an unlocked position, the pawl may remain in the unlocked position until the first conductive wire is heated. The pawl may remain in the unlocked position even when no electrical power is supplied to the door lock system Similarly, after the pawl is moved into the locked position, it may remain in the locked position until the second conductive wire is heated. The pawl may remain in the locked position even when no electrical power is supplied to the door lock system.

### BRIEF DESCRIPTION OF SEVERAL VIEWS OF THE DRAWINGS

FIG. 1 illustrates a top exploded view of a conventional door lock mechanism.

FIG. 2 illustrates a bottom view of a conventional main module.

FIG. 3 illustrates a top isometric view of a door lock system according to an embodiment of the present invention.

FIG. 4 illustrates a schematic representation of a door lock system in a locked position according to an embodiment of the present invention.

FIG. 5 illustrates a schematic representation of a door lock system in an unlocked position according to an embodiment of the present invention.

Before the embodiments of the invention are explained in detail, it is to be understood that the invention is not limited in its application to the details of construction and the arrangement of the components set forth in the following description or illustrated in the drawings. The invention is capable of other embodiments and of being practiced or being carried out in various ways. Also, it is to be understood that the phraseology and terminology used herein are for the purpose of description and should not be regarded as limiting. The use of “including” and “comprising” and variations thereof is meant to encompass the items listed thereafter and equivalents thereof as well as additional items and equivalents thereof.

### DETAILED DESCRIPTION OF THE INVENTION

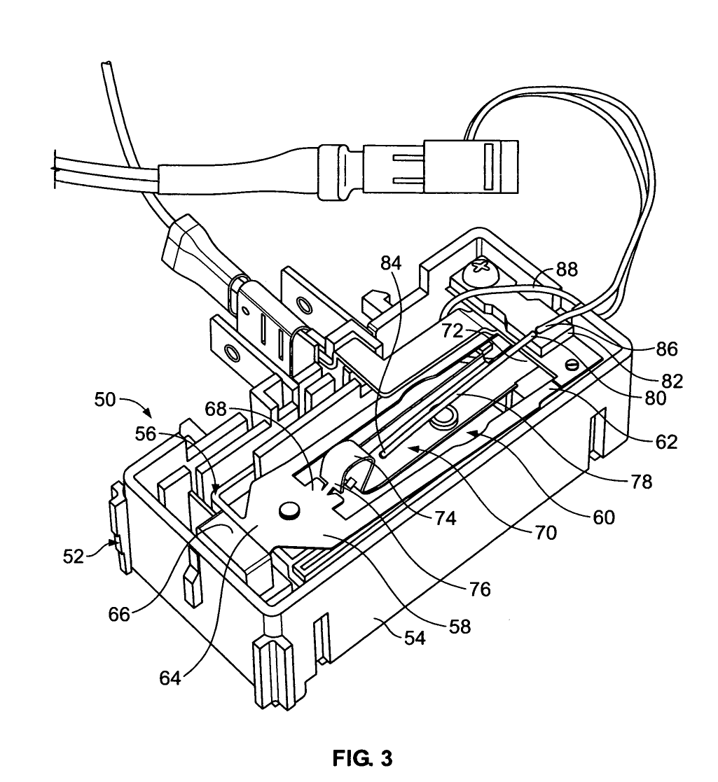

FIG. 3 illustrates a top isometric view of a door lock system 50 according to an embodiment of the present invention. The door lock system 50 includes a main module 52 having a housing 54 defining an interior chamber 56. A beam 58 having an interior opening 60 is positioned within the interior chamber 56 such that a fixed end 62 of the beam 58 is secured within the housing 54, and a free end 64 of the beam 58 may move within the interior chamber 56. A pawl 66 extends downwardly from the beam 58 proximate the free end 64. The beam 58 also includes a spring-engagement edge 68 positioned between the interior opening 60 and the pawl 66.

The door lock system 50 also includes a lever arm 70 having a fixed end 72 secured within the housing 54. A horse-shoe shaped spring 74 is integrally connected to an opposite end of the lever arm 70. A free end 76 of the spring 74 abuts against the spring-engagement edge 68, thereby exerting a force into the spring engagement edge 68.

A top wire 78, having a first end 80 secured to a terminal block 82 and a second end 84 connected to a top surface of the lever arm 70, is electrically connected to a power source through lead wire 86. A bottom wire (not shown in FIG. 3), having a first end (not shown in FIG. 3) secured to the electrical block 82 and a second end (not shown in FIG. 3) to a bottom surface of the lever arm 70, is electrically connected to a power source through lead wire 88. The top wire 78 and the bottom wire may be soldered, crimped, bonded, or otherwise electrically coupled to the lever arm 70. Electrical current is passed through the top wire 78 and the bottom wire in order to move the door lock system 50 between locked and unlocked positions, as discussed below.

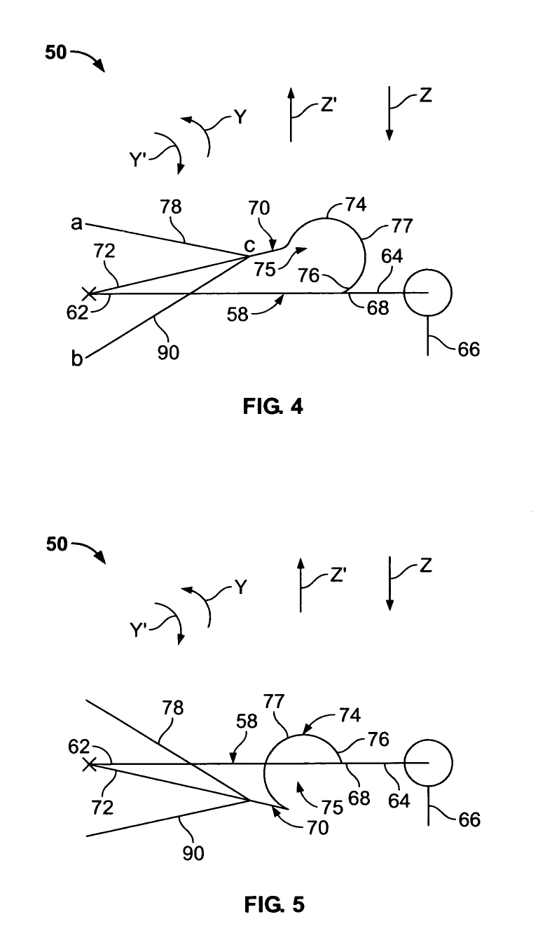

FIG. 4 illustrates a schematic representation of the door lock system 50 in a locked position. As shown in FIG. 4, a bottom wire 90 is connected to a bottom surface of the lever arm 70. The top and bottom wires 78 and 90 are shape memory alloy (SMA) wires, which contract in length when heated to a fixed transition temperature, such as, for example, 90° Celsius. Current is applied to the top and bottom wires 78 and 90 through an electrical source (not shown) to heat the top and bottom wires 78 and 90. The contraction of the wires 78 and 90 (caused by the heating of the wires 78 and 90) occurs almost instantaneously. Further, when current through the wires 78 and 90 discontinues, the wires 78 and 90 quickly cool down and return to their original lengths (in about one second or less).

As shown in FIG. 4, the ends of the beam 58 and the lever arm 70 are both fixed within the main module housing (not shown in FIG. 4) about a planar position denoted by X. As such, the beam 58 and the lever arm 70 may pivot about the position X. The free end 76 of the spring 74 integrally connected to the lever arm 70 exerts a force into the spring-engagement edge 68 of the beam 58.

As current is supplied to the top wire 78, the top wire 78 contracts or otherwise shortens, thereby pulling on the top side of the lever arm 70 and pivoting the attached lever arm 70 in the direction of arc Y. As the lever arm 70 pivots about the position X in the direction of arc Y, the force exerted by the spring 74 into the beam 58 increases due to the horseshoe shape of the spring 74. The increased force exerted by the spring 74 into the spring engagement edge 68 pivots the beam 58 about the position X in the direction of Y′. As the beam 58 pivots in the direction of Y′, the pawl 66 moves outwardly from the main module 52 (shown in FIG. 3), thereby positioning the door lock system 50 in a locked state. Because electrical power is not applied to the bottom wire 90 during this time, the bottom wire 90 offers little or no resistance to the pulling force exerted on the lever arm 70 by the top wire 78.

As shown in FIG. 4, the horseshoe shape of the spring 74 is such that the open end 75 of the horseshoe faces downward in the locked position. Further, no portion of the closed end 77 of the horseshoe shaped spring 74 is below the plane of the beam 58 in the locked position.

When application of electrical power to the top wire 78 is discontinued such that current no longer flows through the top wire 78, the top wire 78 cools. As the top wire 78 cools, the top wire 78 expands back to its original length. Even though electrical current no longer flows through the top wire 78, the lever arm 70, and therefore the beam 58 and the pawl 66, remain in the locked position due to the spring 74 so long as electrical power is not supplied to the bottom wire 90. That is, the spring 74 maintains the beam 58 and pawl 66 in the locked position. Thus, the system 50, in particular the top wire 78, does not need to be continually energized in order to maintain the system 50 in a locked position.

While the door lock system 50 is shown having top and bottom wires 78 and 90, the system 50 may alternatively utilize a single wire that spans from point a to point c, and point c to point b. In order to position the system 50 into a locked state, segment a-c is heated. In order to position the system into an unlocked state, the segment b-c is heated.

FIG. 5 illustrates a schematic representation of the door lock system 50 in an unlocked position. As current is supplied to the bottom wire 90, the bottom wire 90 contracts or otherwise shortens, thereby pulling on the underside of the lever arm 70 and pivoting the attached lever arm 70 in the direction of arc Y′. As the lever arm 70 pivots about the position X in the direction of arc Y′, the force exerted by the spring 74 into the beam 58 increases due to the horseshoe shape of the spring 74. The increased force exerted by the spring 74 allows the beam 58 to pivot about the position X in the direction of Y. As the beam 58 pivots back in the direction of Y, the pawl 66 recedes back into the main module 52 (shown in FIG. 3), thereby positioning the door lock system 50 in an unlocked state. Because electrical power is not applied to the top wire 78 during this time, the top wire 78 offers little or no resistance to the pulling force exerted on the lever arm 70 by the bottom wire 90.

As shown in FIG. 5, the horseshoe shape of the spring 74 is such that the open end 75 of the horseshoe is positioned within the plane of the beam 58 in the unlocked position. Further, a portion of the closed end 77 of the horseshoe shaped spring 74 is positioned below the plane of the beam 58 in the unlocked position.

When application of electrical power to the bottom wire 90 is discontinued such that current no longer flows through the bottom wire 90, the bottom wire 90 cools. As the bottom wire 90 cools, the bottom wire 90 expands back to its original length. Even though electrical current no longer flows through the bottom wire 90, the lever arm 70, and therefore the beam 58 and the pawl 66, remain in the unlocked position due to the spring 74 so long as electrical power is not supplied to the top wire 78. That is, the spring 74 maintains the beam 58 and pawl 66 in the unlocked position. Thus, the system 50, in particular the bottom wire 90, does not need to be continually energized in order to maintain the system 50 in an unlocked position.

While the spring 74 is configured to exert increased force into the beam 58 when the lever arm 70 pivots back in the direction of arc Y, the system 50 may alternatively be configured so that as the lever arm 70 moves in the direction of Y′, an attached engagement member exerts increased force into the beam 58 in the same direction. Thus, the system 50 may be configured so that when the lever arm 70 moves in one direction, the beam 58 moves in the same direction. For example, instead of a horseshoe shaped spring, the system 50 may include a straight member connected to the lever arm 70 at a right angle.

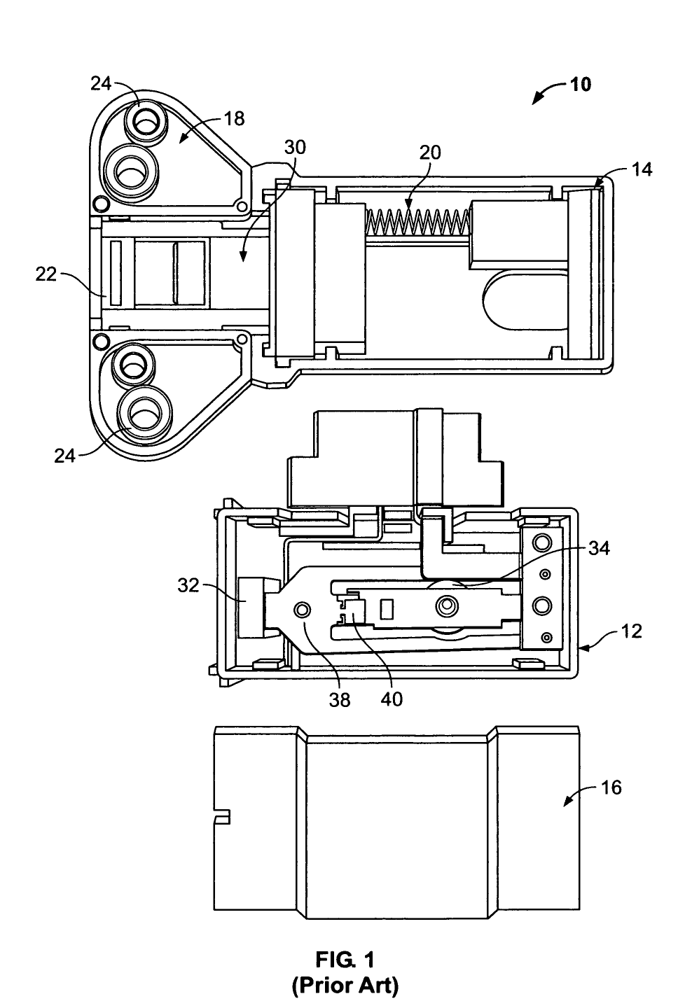

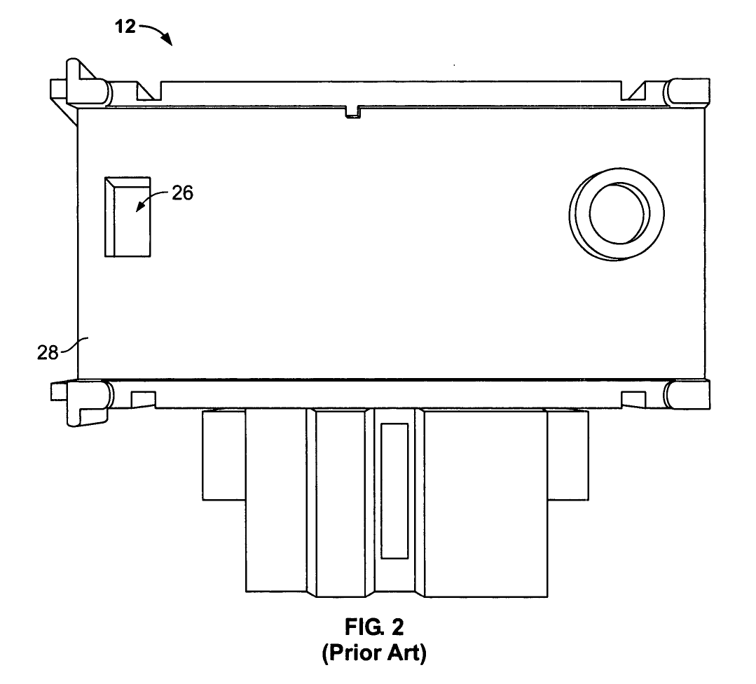

Compared to the door lock mechanism 10 shown in FIG. 1, the door lock system 50 includes less components and mechanical connections. In particular, the door lock system 50 utilizes simpler components and mechanical connections to move the pawl between locked and unlocked positions as compared to those of the door lock mechanism 10 (shown in FIG. 1). Additionally, the door lock system 50 does not need to be continually energized in order to maintain the pawl 66 in locked or unlocked positions. Further, the door lock system 50 may be moved between locked and unlocked positions quicker than the door lock mechanism 10 because the system 50 does not utilize a PTC pill that takes a relatively long time to cool.

Thus, embodiments of the present invention provide a simpler, cheaper, less bulky and more efficient door lock system. Additionally, embodiments of the present invention provide a door lock system that allows a door to be unlocked quicker. Further, embodiments of the present invention provide a door lock system that does not need to be continually energized in order to stay locked.

Variations and modifications of the foregoing are within the scope of the present invention. It is understood that the invention disclosed and defined herein extends to all alternative combinations of two or more of the individual features mentioned or evident from the text and/or drawings. All of these different combinations constitute various alternative aspects of the present invention. The embodiments described herein explain the best modes known for practicing the invention and will enable others skilled in the art to utilize the invention. The claims are to be construed to include alternative embodiments to the extent permitted by the prior art.

Various features of the invention are set forth in the following claims.

1. A door lock system comprising:
a deflectable beam;
a pawl positioned on said deflectable beam;
a lever member exerting a force into at least a portion of said deflectable beam;
first and second conductive wires attached to said lever member,
wherein said first conductive wire contracts when heated, thereby pulling on said lever member and pivoting said lever member into a first position wherein said deflectable beam deflects so that said pawl is moved into a locked position, and wherein said second conductive wire contracts when heated, thereby pivoting said lever member into a second position wherein said deflectable beam deflects so that said pawl is moved into an unlocked position.

2. The door lock system of claim 1, further comprising electrical leads, wherein said each of said first and second conductive wires are electrically connected to one of said electrical leads, wherein current is applied to said first and second conductive wires thereby heating said first and second conductive wires.

3. The door lock system of claim 1, further comprising a main module having a housing defining an interior chamber, wherein said deflectable beam, said pawl, said lever member, and said first and second conductive wires are positioned within said interior chamber.

4. The door lock system of claim 3, wherein a pivoting end of said deflectable beam is pivotally secured within said housing, and wherein a pivoting end of said lever member is pivotally secured within said housing.

5. The door lock system of claim 1, wherein said lever member comprises a lever arm connected to a spring, wherein a distal end of said spring contacts said deflectable beam.

6. The door lock system of claim 5, wherein said spring is horseshoe shaped.

7. The door lock system of claim 1, wherein said lever member pivots in a first direction, while said deflectable beam deflects in a second direction that is opposite the first direction when one of said first and second conductive wires contracts.

8. The door lock system of claim 1, wherein said lever member and said deflectable beam both move in a first direction when one of said first and second conductive wires contracts.

9. The door lock system of claim 1, wherein after said pawl is moved into the unlocked position, said pawl remains in the unlocked position until said first conductive wire is heated, and wherein after said pawl is moved into said locked position, said pawl remains in the locked position until said second conductive wire is heated.

10. The door lock system of claim 1, wherein after said pawl is moved into the locked position, said pawl remains in the unlocked position even when no electrical power is supplied to the door lock system, and wherein after said pawl is moved into the unlocked position, said pawl remains in the locked position even when no electrical power is supplied to the door lock system.

11. The door lock system of claim 1, wherein said first and second conductive wires are composed of a shape memory alloy.

12. The door lock system of claim 1, wherein said deflectable beam and said lever member are stamped as a single component.

13. A door lock system comprising:
a deflectable beam comprising a beam fixed end and a beam free end;
a pawl positioned on said deflectable beam;
a lever member exerting a force into at least a portion of said deflectable beam, said lever member comprising a lever fixed end a lever free end;
first and second conductive wires attached to said lever member;
electrical leads electrically connected to said first and second conductive wires, wherein said electrical leads are configured to allow electrical current to pass through said first and second conductive wires, wherein the electrical current heats said first and conductive wires,
a module housing said deflectable beam, said pawl, said lever member, and said first and second conductive wires therein,
wherein said first conductive wire contracts when heated, thereby pulling on said lever member and pivoting said lever member into a first position wherein said deflectable beam deflects so that said pawl is moved into a locked position, and wherein said second conductive wire contracts when heated, thereby pivoting said lever member into a second position wherein said deflectable beam deflects so that said pawl is moved into an unlocked position.

14. The door lock system of claim 13, wherein said beam fixed end is pivotally secured within said housing, and wherein said lever fixed end is pivotally secured within said housing.

15. The door lock system of claim 13, wherein said lever member comprises a lever arm connected to a spring, wherein a distal end of said spring contacts said deflectable beam.

16. The door lock system of claim 15, wherein said spring is horseshoe shaped.

17. The door lock system of claim 13, wherein said lever arm pivots in a first direction, while said deflectable beam deflects in a second direction that is opposite the first direction when one of said first and second conductive wires contracts.

18. The door lock system of claim 13, wherein said lever arm and said deflectable beam both move in a first direction when one of said first and second conductive wires contracts.

19. The door lock system of claim 13, wherein after said pawl is moved into the unlocked position, said pawl remains in the unlocked position until said first conductive wire is heated, and wherein after said pawl is moved into said locked position, said pawl remains in the locked position until said second conductive wire is heated.

20. The door lock system of claim 13, wherein after said pawl is moved into the locked position, said pawl remains in the unlocked position even when no electrical power is supplied to the door lock system, and wherein after said pawl is moved into the unlocked position, said pawl remains in the locked position even when no electrical power is supplied to the door lock system.

21. The door lock system of claim 13, wherein said first and second conductive wires are composed of a shape memory alloy.

22. The door lock system of claim 13, wherein said deflectable beam and said lever member are stamped as a single component.

23. A door lock system comprising:
a deflectable beam;
a pawl positioned on said deflectable beam;
a lever member exerting a force into at least a portion of said deflectable beam, said lever member comprising a lever arm connected to a horseshoe-shaped spring, wherein a distal end of said spring contacts said deflectable beam;
first and second conductive wires attached to said lever member;
electrical leads electrically connected to said first and second conductive wires, wherein said electrical leads are configured to allow electrical current to pass through said first and second conductive wires, wherein the electrical current heats said first and conductive wires,
wherein said first conductive wire contracts when heated, thereby pulling on said lever member and pivoting said lever member into a first position wherein said deflectable beam deflects so that said pawl is moved into a locked position, and wherein said second conductive wire contracts when heated, thereby pivoting said lever member into a second position wherein said deflectable beam deflects so that said pawl is moved into an unlocked position.

24. The door lock system of claim 23, wherein said lever arm pivots in a first direction, while said deflectable beam deflects in a second direction that is opposite the first direction when one of said first and second conductive wires contracts.

25. The door lock system of claim 23, wherein said lever arm and said deflectable beam both move in a first direction when one of said first and second conductive wires contracts.

26. The door lock system of claim 23, wherein after said pawl is moved into the unlocked position, said pawl remains in the unlocked position until said first conductive wire is heated, and wherein after said pawl is moved into said locked position, said pawl remains in the locked position until said second conductive wire is heated.

27. The door lock system of claim 23, wherein said pawl remains in an unlocked position even when no electrical power is supplied to the door lock system, and wherein said pawl remains in a locked position even when no electrical power is supplied to the door lock system.

28. The door lock system of claim 23, wherein said first and second conductive wires are composed of a shape memory alloy.

29. The door lock system of claim 23, wherein said deflectable beam and said lever member are stamped as a single component.
